(19) United States
(12) Patent Application Publication
(10) Pub. No.: US 2002/0108968 A1
(43) Pub. Date: Aug. 15, 2002

(54) Dispensing container having removable auxiliary supply vessel and dual coaxial tube mixing/dispensing system

(76) Inventor: Charles Dumont, Miami, FL (US)

Correspondence Address: David L. Banner, P.O. Box 2607, Fairfax, VA, 22031, US

(21) Appl. No.: 09/781,166

(22) Filed: Feb. 13, 2001

Related U.S. Application Data
(60) Provisional application No. 60/192,562, filed on Mar. 28, 2000.

(51) Int. Cl. B67D 5/52

(52) U.S. Cl. 222/136; 222/145.6; 222/321.9

(57) ABSTRACT

A dispensing bottle which stores two separated fluids and blends the fluids when dispensing. The bottle has two liquid receptacles and a cap which threads to the bottle. The receptacles include the open interior of the bottle, and an interior vessel separate and removable from the bottle. The cap includes a mixing circuit which retrieves and blends fluids taken from the receptacles. The mixing circuit includes a pick-up tube to each receptacle, coaxially aligned, one within the other, a mixing chamber and a check valve preventing backflow of mixed fluids into the storage receptacles. A proportioning valve adjusts the proportions of the fluids entering the mixing chamber. The bottle has a plunger type pump which propels mixed fluid to a discharge nozzle. The pump optionally has mixing blades projecting therefrom and/or mixing balls therein for blending the fluids.

### CROSS REFERENCE TO RELATED APPLICATIONS

This application is a Continuation-In-Part of Provisional Application Ser. No. 60/192,562 filed Mar. 28, 2000.

### BACKGROUND OF THE INVENTION

1. Field of the Invention

The present invention relates to containers which blend fluent materials, stored in separate chambers, when dispensing these materials. More particularly, the invention comprises a dispensing pump for discharging fluids stored within the container's chambers by way of a pair of pick-up tubes situated coaxially, one within the other, such that the inner tube extends through a first container into a second container mounted below the first. The novel dispensing container finds application wherever fluid materials must be blended and dispensed in quantities appropriate for individual consumers. For example, the container may be utilized by consumers to store and dispense personal care products such as shampoo and hair conditioner, cooking products such as sweeteners and colorants, and food products such as oil and vinegar for preparing salad dressings, among others. Alternatively, the container may be utilized in industrial, commercial, institutional, medical and scientific applications to blend active ingredients with carrier fluids, or to blend ingredients which would interact with one another. The fields which may benefit from the invention are many and diverse.

2. Description of the Prior Art

From time to time, it is necessary to dispense several dissimilar fluent substances which must be separated from one another prior to being utilized, yet blended when utilized. In many cases, the precise proportions of the two substances cannot be determined until the last minute. If the two substances were stored separately, it would require extreme care to assure that they be accurately mixed together. Also, metering and dispensing of two separate substances is somewhat time consuming. Furthermore, separate metering and dispensing may expose one or both substances to contact with the air, airborne contaminants, light, or other detrimental influences.

Another aspect of containers is that in many cases it is not feasible to provide separate fluids in proportional ratios. That is, it is frequently the case that one fluid is depleted while a usable quantity of another fluid yet remains. The fluid may be among the contents being dispensed, or alternatively may be a carrier fluid or a propellant. To this end, it would be desirable to provide a container which accommodates connection of a separate vessel containing one of the fluids.

This feature is shown in U.S. Pat. No. 5,908,107, issue4d to Baudin, et. al., on Jun. 1, 1999, wherein one vessel threads to another. However, the device of Baudin lacks the mixing and dispensing pump of the present invention, and also lacks alignable ports or valves which enable immediate communication between the two receptacles when the detachable vessel is connected to the principal container.

It is convenient and effective to store, meter, blend and dispense several substances from a single container in a manner assuring that plural contents be separated until the point in time at which they are used. The prior art has proposed containers which dispense plural contents. An example is in U.S. Pat. No. 3,850,346, issued to James E. Richardson, et. al., on Nov. 26, 1974. The subject dispenser of Richardson is hand squeezed to dispense fluids, whereas the present invention includes a pump. The present invention also has an internal circuit cooperating with a removable vessel.

U.S. Pat. No. 5,439,137, issued to Jean-Francois Grollier, et. al., on Aug. 8, 1995, shows an aerosol type dispenser having plural fluid containers which dispense fluids. Unlike the present invention, there is no manual pump and no separable, connectable vessel.

U.S. Pat. No. 5,127,548, issued to Michael Brunet, et. al., on Jul. 7, 1992, features a dispenser having a plunger pump at one end and a discharge nozzle at the other end, in the manner of a hypodermic syringe. Actuation of the plunger ruptures a barrier which separates two stored fluids. Unlike the present invention, Brunet would require renewing of the frangible barrier for each subsequent use. Brunet also provides no mixing circuit incorporating check valves, as seen in the present invention, and no separable, connectable vessel. In the present invention, fluid is discharged through the pump, a feature not offered by the device of Brunel.

U.S. Pat. No. 5,588,550, issued to Robert C. Meyer on Dec. 31, 1996, illustrates a compartmented container which dispenses plural fluids in adjustable proportion. However, Meyer lacks a plunger pump and a dispensing circuit having check valves and an internal mixing chamber, or a separable, connectable vessel, as seen in the present invention.

U.S. Pat. No. 5,890,624, issued to William M. Klima, et. al., on Apr. 6, 1999, shows a dispensing container providing plural storage compartments and an indirectly operated plunger pump. Klima has a dispensing circuit incorporating check valves and a mixing chamber, however, it lacks a separable, connectable vessel, an agitator or mixing structure carried on the piston of the pump, and an internal support for supporting one of the storage compartments within the container. By contrast, these features are all seen in the present invention. Klima has a plunger type pump, but his pump is indirectly actuated by a trigger and associated linkage, whereas the pump of the present invention is directly actuated.

None of the above inventions and patents, taken either singly or in combination, is seen to describe the instant invention as claimed.

### SUMMARY OF THE INVENTION

The present invention affords a hand held, pump action dispensing container or dispenser which is suitable for enabling consumers to blend and dispense many different fluids. The novel container has a storage receptacle in the form of a jar or bottle for containing one fluid, open at one end, and threaded for securing a cap which bears a discharge nozzle. Mounted either within or above the novel container is a separate, auxiliary vessel for containing a second fluid, isolated from the contents of the first container during storage. Depending from the discharge nozzle are a pair of pick-up tubes, situated coaxially, one within the other, such that the inner tube extends through the auxiliary vessel into the novel container. Fluids contained within the compartments may be mixed in a mixing chamber contained within the discharge nozzle in any desired proportion prior to discharge.

The auxiliary vessel contains a second fluid which may interact with the first fluid contained within the container, or which may be a carrier fluid, a propellant, such as pressurized gas, or which may serve some other purpose. The container has passages which are opened by installing the separate vessel in the container. These passages establish communication between a compartment of the dispenser and the separate vessel.

Communication occurs only when the separate vessel is installed in the container of the dispenser. Selectively opened passages enable residual pressure, in containers operated by pressurized propellant, to be vented relieved prior to opening the container, and without unduly depleting the source of propellant. Withdrawal of the vessel closes passages such that no undesired leakage to the outside of the container occurs.

A principle application of the invention is to provide pressurized propellant gas in a small, inexpensive vessel so that the principal container can be economically fabricated from an inexpensive material, such as plastic. The pressure vessel can be fabricated from aluminum, steel, or any other suitable material.

The pressure vessel is removed from the principal container. This leads to certain advantages apart from cost of the container and attachable vessel. For example, depletion of one of the fluids need not cause the container and any remaining quantity or the other fluid to be discarded. Both fluids can be renewed as desired. Therefore, mismatches in quantity between propellant and the fluid being dispensed can be overcome. Both the fluid being dispensed and the propellant can independently, and at any time, be renewed, as required. This feature enables usage of the container to continue with minimal regard for depletion of either propellant or of the fluid being dispensed.

A dispensing circuit enclosed within the container has a pick up tube for each compartment of the container, a common mixing chamber, and check valves to prevent cross contamination of storage compartments by backflow within the mixing circuit and to isolate the mixing chamber from exposure to the outside atmosphere.

The dispensing circuit and its conduits are secured to the cap. One of several types of pumps are incorporated to achieve forced dispensing. A manual plunger type pump is one possible type of pump. The plunger pump operates by direct action, that is, its upper portion is contacted by the user's hand and depressed. Depressing the plunger directly pressurizes fluid contained in the mixing chamber. Pressurized fluid can escape only through the discharge nozzle. A spring returns the plunger to its original position, where it is ready for the next pressurizing stroke. The return stroke generates a partial vacuum in the mixing chamber which recharges the mixing chamber with fluids retrieved from storage. An optional proportioning valve adjusts proportions of fluids retrieved from storage. An electrically operated pump is an alternative to a manual pump.

Optionally, paddles, vases or small balls are carried on the pump or inside the mixing chamber to improve blending within the mixing chamber. This option is used when highly viscous fluids are to be mixed, or when dispensing any fluids which resist spontaneous mixing. In a further option, a support cage or frame for supporting a small storage container within the bottle or jar depends from the cap.

A significant advantage of the invention is that pre-existing spray heads can be utilized with minor transformation. This is of interest to manufacturers who will be able to utilize existing tooling to fabricate the spray head.

Another advantage of the invention is that the container, together with its internal circuits and valve features, can be manufactured by known molding techniques in a homogenous single part, or in relatively few mutually attachable parts. Materials utilized to fabricate the container are readily recyclable.

Accordingly, it is a principal object of the invention to provide a hand held dispenser which blends and dispenses plural fluids which must be stored separately from one another.

It is another object of the invention is to provide a hand held fluid dispenser which has a removably attachable auxiliary vessel, and which dispenser receives fluid from the auxiliary vessel.

It is a further object of the invention to provide the different pick-up tubes to be assembled one inside the other. The tubes depart from the top valve of the dispenser to reach each one a different container are in line and are fitted one inside the other to form a single tube from the outside, however they are more than one tube from the inside. No connection is made between them along the suction line. Each tube will pick up a different product and will deliver it to the mixing chamber.

It is an object of the invention to provide improved elements and arrangements thereof in an apparatus for the purposes described which is inexpensive, dependable and fully effective in accomplishing its intended purposes.

These and other objects of the present invention will become readily apparent upon further review of the following specification and drawings.

### BRIEF DESCRIPTION OF THE DRAWINGS

Various other objects, features, and attendant advantages of the present invention will become more fully appreciated as the same becomes better understood when considered in conjunction with the accompanying drawings, in which like reference characters designate the same or similar parts throughout the several views, and wherein:

FIG. 1 is a cross sectional, side elevational view of one embodiment of the discharge nozzle, mixing chamber and pick-up tubes.

FIG. 2 is a cross sectional, side elevational view of a preferred embodiment of the invention with its container and auxiliary vessel attached.

FIG. 3 is a cross sectional, side elevational view of a second embodiment of the invention with its container and auxiliary vessel attached in a different manner.

### DETAILED DESCRIPTION OF THE PREFERRED EMBODIMENTS

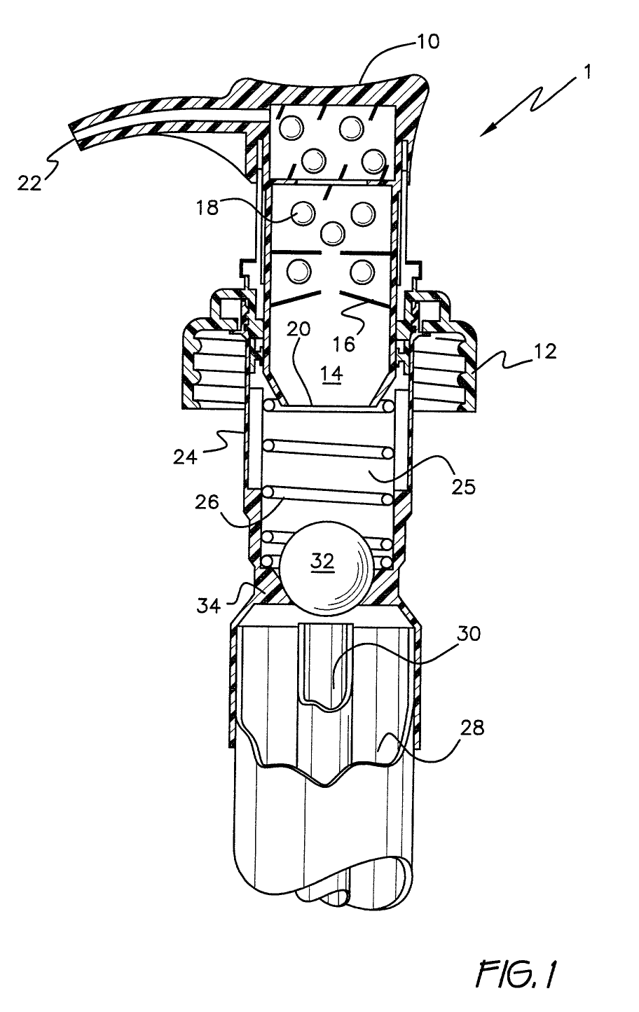

Referring to FIG. 1, pump head 10 is mounted to and penetrating through threaded cap 12. Within pump head 10 is mixing chamber 14 containing mixing paddles 16 and/or mixing balls 18 for facilitating the mixing of separate fluids into a single mixture. Mixing chamber 14 has an aperture 20 at its lower extreme, and leading from its upper extreme 14 is nozzle passage 22 in an extension of pump head 10. Pump head 10 is fitted into pump housing 24 such that it is forced against a retaining lip at the upper extreme of pump housing 24 by spring 26. Outer pick-up tube 28 depends from the inner surface of pump housing 24 at its lower extreme. Inner pick-up tube 30 is suspended within outer pick-up tube 28 coaxially. Ball valve 32, when resting on ball valve shoulder 34 seals both outer pick-up tube 28 and inner pick-up tube 30.

The operation of pump 1 is typical of current single tube pumps in that depression of pump head 10 compresses spring 26. Releasing downward pressure on pump head 10 allows spring 26 to recoil, forcing pump head 10 upwards, creating a partial vacuum in pump chamber 25. Ball valve 32 is pulled into the vacuum of pump chamber 25, opening the passages between outer pick-up tube 28 and inner pick-up tube 30 and pump chamber 25, drawing liquids from their individual storage chambers into pump chamber 25. Once the vacuum is filled, ball valve 32 drops back into position, sealing the passages between outer pick-up tube 28 and inner pick-up tube 30 and pump chamber 25. A second depression of pump head 10 forces the fluids in pump chamber 25 into mixing chamber 14 where mixing paddles 16 and/or mixing balls 18 mix the fluids, which are then forced out of mixing chamber 14 through nozzle passage 22. Release of the downward pressure on pump head 10 again allow spring 26 to recoil, forcing pump head 10 upwards repeating the processing of drawing additional fluids into pump chamber 25.

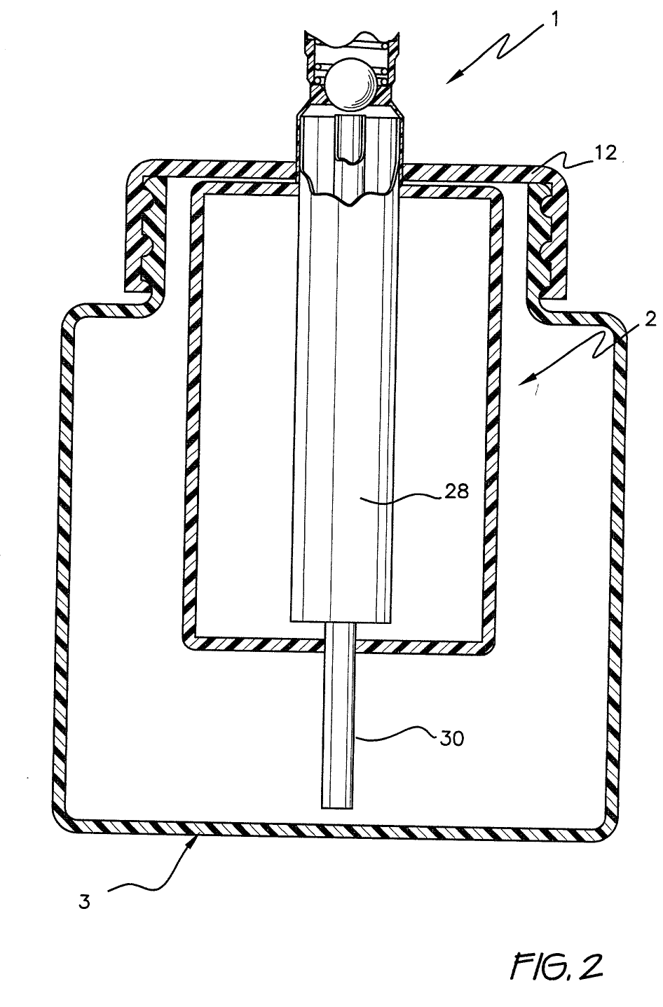

Turning now to FIG. 2, auxiliary vessel 2 is manufactured as an integral part of pump 1 such that auxiliary vessel 2 is a continuation of pump housing 24. Outer pick-up tube 28 extends proximate the bottom of auxiliary vessel 2. Inner pick-up tube 30 is molded as an integral part of auxiliary vessel 2, extending vertically through the center of auxiliary vessel 2, projecting upwards from the top of auxiliary vessel 2, communicating with outer pick-up tube 28 and ball valve 32 and downwards from the bottom of auxiliary vessel 2 such that a flexible extension can be attached thereto, descending into container 3.

It would be evident to one skilled in the art that auxiliary vessel 2 could be designed to fit within container 3, as in FIG. 2 or be mounted above container 3 by placing the threads of threaded cap 12 at the bottom of auxiliary vessel 2 (not shown).

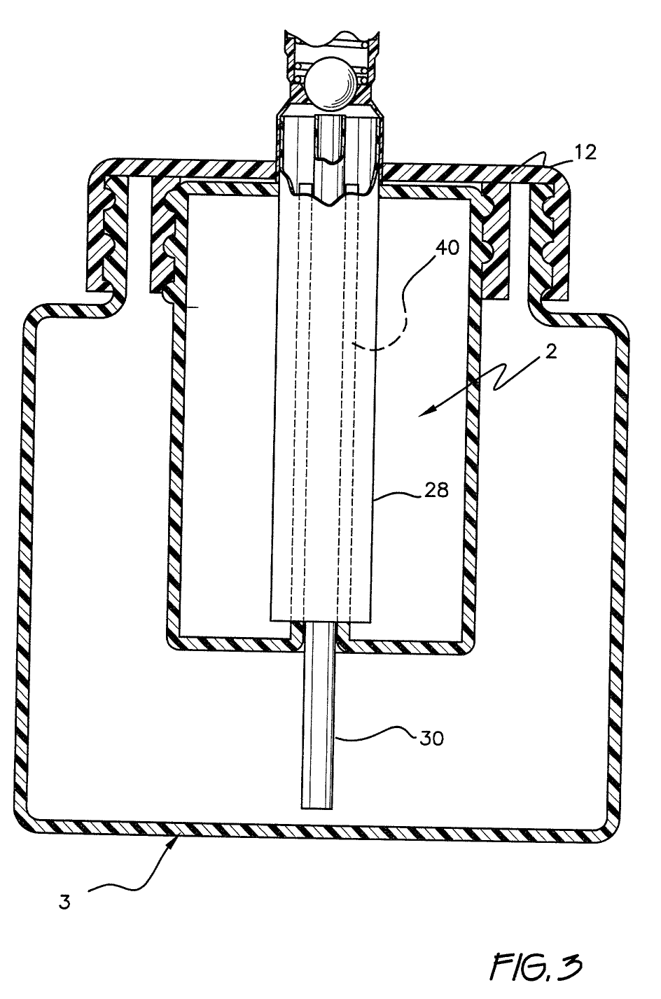

As an alternative embodiment, auxiliary vessel 2 could be produced as a separate piece by providing an inner tube conduit 40 vertically through the center of auxiliary vessel 2, as shown in FIG. 3, whereby inner tube 30 could pass through the center of auxiliary vessel 2 without exposing the contents of auxiliary vessel 2 to the atmosphere or the contents of container 2. In this embodiment, auxiliary vessel 2 could be threaded to fit within container 3 with a dually threaded cap 12, as shown in FIG. 3, or mounted atop container 3 by including female threads at the bottom of auxiliary vessel 2 to receive the male threads of container 3 (not shown).

It would be evident to one skilled in the art that there would be other methods of joining container 3, auxiliary vessel 2 and pump 1 which would be equally desirable as those presented.

It would likewise be evident that container 3 and auxiliary vessel 2 could be produced of a variety of materials, including plastic, glass and metals, as the particular use would dictate.

It is to be understood that the present invention is not limited to the embodiments described above, but encompasses any and all embodiments within the scope of the following claims.

I claim:

1. A dispensing container for storing fluids separately and blending and dispensing these fluids, comprising;
a container having a bottom, a lateral wall, an open upper end and a first receptacle;
an auxiliary vessel dimensioned and configured to be insertable into and contained within said container, said auxiliary vessel having a second receptacle; and
a cap closely engageable with said upper end of said container, said cap having a mixing and dispensing circuit including
a first pick-up tube communicating with said first receptacle of said container coaxially positioned within
a second pick-up tube extending from said cap to said second receptacle,
a mixing chamber disposed in fluid communication with said first pick-up tube and said second pick-up tube,
a pump disposed to pressurize and propel fluids contained within said mixing chamber, and
a nozzle passage opening to the outside atmosphere.

2. The dispensing container as defined in claim 1, wherein said mixing circuit includes a check valve disposed between said mixing chamber and said first pick-up tube and said second pick-up tube, wherein said check valve prevents backflow into said first pick-up tube and said second pick-up tube.

3. The dispensing container as defined in claim 1, wherein said pump comprises a pump head accessible to manual contact from above said cap.

4. The dispensing container as defined in claim 3, further comprising a spring disposed to urge said pump head toward a ready position.

5. The dispensing container as defined in claim 3, wherein said mixing chamber has mixing blades projecting from the walls thereof.

6. The dispensing container as defined in claim 3, wherein said mixing chamber has mixing balls contained therein.

7. The dispensing container as defined in claim 1, wherein said auxiliary vessel is an integral part of said cap and occupies said first receptacle of said container.

8. A dispensing container for storing fluids separately and blending and dispensing these fluids, comprising;
a container having a bottom, a lateral wall, an open upper end and a first receptacle enclosed within said bottom and lateral wall;
an auxiliary vessel dimensioned and configured to be insertable into and contained within said container, said auxiliary vessel having a second receptacle enclosed therein, wherein said auxiliary vessel is an integral part of
a cap closely engageable with said upper end of said container, said cap having a mixing and dispensing circuit including
a first pick-up tube communicating with said first receptacle of said container coaxially positioned within
a second pick-up tube extending from said cap to said second receptacle,
a mixing chamber disposed in fluid communication with said first pick-up tube and said second pick-up tube,
a pump disposed to pressurize and propel fluids contained within said mixing chamber, and
a nozzle passage opening to the outside atmosphere.

9. The dispensing container as defined in claim 8, wherein said first pick-up tube extends through said auxiliary vessel and terminates in said first receptacle of said container.

10. The dispensing container as defined in claim 8, wherein said mixing circuit includes
a check valve disposed between said first pick-up tube and said second pick-up tube and said mixing chamber to prevent backflow into said first pick-up tube and said second pick-up tube.

11. A dispensing container for storing fluids separately and blending and dispensing these fluids, comprising;
a container having a bottom, a lateral wall, an open upper end and a first receptacle enclosed within said bottom and lateral wall;
an auxiliary vessel dimensioned and configured to be insertable into and contained within said container, said auxiliary vessel having a second receptacle enclosed therein,
wherein said auxiliary vessel has a pick-up tube conduit molded vertically through the center of said auxiliary vessel whereby a first pick-up tube may pass through the center of said auxiliary vessel without exposing the contents of auxiliary vessel 2 to the atmosphere or the contents of said container;
a cap closely engageable with said upper end of said container and said auxiliary vessel, said cap having a mixing and dispensing circuit including
said first pick-up tube communicating with said first receptacle of said container coaxially positioned within
a second pick-up tube extending from said cap to said second receptacle,
a mixing chamber disposed in fluid communication with said first pick-up tube and said second pick-up tube,
a pump disposed to pressurize and propel fluids contained within said mixing chamber, and
a nozzle passage opening to the outside atmosphere.
